(19) United States
(12) Patent Application Publication
(10) Pub. No.: US 2017/0013679 A1
(43) Pub. Date: Jan. 12, 2017

(54) Windowpane System and Vehicle Incorporating Same

(71) Applicant: JAGUAR LAND ROVER LIMITED, Coventry, Warwickshire (GB)

(72) Inventor: Ashutosh Tomar, Coventry, Warwickshire (GB)

(21) Appl. No.: 15/117,927

(22) PCT Filed: Feb. 12, 2015
(86) PCT No.: PCT/EP2015/053011

§ 371 Date: Aug. 10, 2016

(30) Foreign Application Priority Data
Feb. 12, 2014 (GB) 1402476.4

(51) Int. Cl. H05B 3/84; G01N 21/55; B60S 1/02; H05B 3/00; G01N 21/958

(52) U.S. Cl. CPC H05B 3/84; H05B 3/0042; G01N 21/958; B60S 1/026; G01N 21/55; H05B 2214/02; G01N 2021/9586; G01N 2201/06113

(57) ABSTRACT

A windowpane system (101) comprising: a windowpane (102); and at least one primary light source (105); each primary light source (105) being arranged so that light (106) from the primary light source (105) passes into the windowpane (102) through a first surface of the windowpane (102), the light (106) then travelling within the windowpane until it has undergone total internal reflection from one or more second surfaces of the windowpane a plurality of times, wherein at least some of the light from the primary light source is absorbed by the windowpane as the light from the primary light source passes through the windowpane.

### TECHNICAL FIELD

This invention relates to a windowpane system, and particularly but not exclusively to a self-heating windowpane and a windowpane which can automatically detect the condition of a windowpane or a flaw in the windowpane. Aspects of the invention relate to a system, to a method and to a vehicle.

### BACKGROUND

Vehicle windowpanes, such as windscreens, are frequently subject to “fogging” and ice formation. Fogging occurs when small water droplets form on the surface of the windowpane and disrupt the passage of light through the windowpane, creating a “fog”. Icing, when ice forms on the windowpane, can also disrupt the passage of light through the windowpane. Both conditions therefore reduce the ability of the driver and other occupants of the vehicle to see the outside world. Therefore any fog or ice should ideally be removed, particularly from the windscreen and the rear window of a vehicle if there is one, before the vehicle is driven.

Both fog and ice can be reduced by heating the windowpane, which causes the fog to evaporate and the ice to melt. One way to heat the windowpane is to direct hot air over the surface of the windowpane. However this can be very inefficient since the hot air will also have the effect of heating the cabin of the vehicle, which the driver may not want. This may therefore cause the occupants of the vehicle some discomfort while also wasting energy on unnecessary heating. In addition, heat may not immediately be available when the vehicle is first entered and activated.

Another way to heat a windowpane is to etch or blend a heater matrix into the glass, and then run a current through the matrix to generate heat. This works but requires a lot of current. In addition, the wires can function as a faraday cage and attenuate mobile or GPS signals within the cabin of the vehicle. Experiments by the inventors in this application have established that a heating matrix reduces mobile and GPS signals by up to 6 dB. Lastly, since the heater matrix is built into the glass, if the matrix malfunctions then the entire windowpane must be replaced.

An improved system or method of heating a windowpane, and in particular the windshield of a vehicle, is therefore desirable.

### SUMMARY OF THE INVENTION

In accordance with an aspect of the present invention there is provided a windowpane system, the windowpane system comprising: a windowpane; and at least one primary light source; each primary light source being arranged so that light from the primary light source passes into the windowpane through a first surface of the windowpane, the light then travelling within the windowpane until it has undergone total internal reflection from one or more surfaces of the windowpane a plurality of times, wherein at least some of the light from the primary light source is absorbed by the windowpane as the light passes through the windowpane.

It may be that as the photons are absorbed by the windowpane, the windowpane is heated. In this way the invention provides a self-heating windowpane system. As the light passes through the windowpane, photons are absorbed by the material of the windowpane, and as the energy of the photons is absorbed the windowpane is heated. The frequency of the light and the optical properties of the windowpane may both be chosen to vary this rate of absorption as desired. Since the light undergoes total internal reflection, the photons are kept within the windowpane for longer, which may help to ensure that more energy is absorbed by the windowpane. The light source may be located outside the windowpane. This makes the light source easier to replace. The first surface may be curved, substantially flat or any other suitable shape. The first surface may be shaped to minimise reflection of the light as it passes into the windowpane. For example, the windowpane may comprise a cut, an indentation in another surface such that the surface of the indentation comprises the first surface.

Photons are absorbed more heavily at points where the beam of light is undergoing total internal reflection. In practice, this means that the light is absorbed more at the surfaces of the windowpane than elsewhere. This may be advantageous, since heating the surface of the windowpane preferentially helps to clear ice and fog on the surface faster.

Typically, the material of the windowpane is chosen to provide a predefined absorption rate for photons of a frequency produced by the primary light source.

It may be that more than half of the light from the primary light source is absorbed by the windowpane as the light passes through the windowpane. It may be that 90 percent of the light from the primary light source is absorbed by the windowpane as the light passes through the windowpane. It may be that substantially all of the light from the primary light source is absorbed by the windowpane as the light passes through the windowpane.

Typically light from the primary light source propagates through the windowpane in a direction substantially parallel with the plane of the windowpane. It may be that the frequency of the light and absorption properties of the glass cooperate so that substantially all the light is absorbed before the primary light source reaches a surface opposed to the first surface of the windowpane.

Typically, the first surface is substantially perpendicular to the plane of the windowpane.

In total internal reflection, a ray of light travelling through a first medium reaches a boundary with a second medium and the ray is refracted such that it remains within the first medium. One such boundary is a surface of the windowpane. Provided that the angle of incidence is great enough, and that the refractive index of the first medium is greater than the refractive index of the second medium, then the ray is refracted such that it remains within the first medium as dictated by the principle of total internal reflection.

The windowpane is typically glass. Alternatively, the windowpane may be a plastic or any other material or composite of materials. Typically the windowpane is substantially transparent, for example to light with a frequency in the spectrum visible to the human eye. Alternatively the windowpane may be translucent or opaque.

The windowpane may be doped with impurities in order to adjust the light absorption characteristics of the windowpane. For example, the windowpane may comprise quantities of Iron Oxide (Fe₂O₃) or Lead Oxide (PbO). The windowpane may be doped with nanoparticles.

The light may undergo total internal reflection from a plurality of surfaces within the windowpane. For example, the light may undergo total internal reflection from a third surface and then a fourth surface. The light may then undergo total internal reflection from the third surface again. One or more surfaces within the windowpane may be treated to become mirrors, so that they will more easily reflect light. One or more surfaces within the windowpane may be shaped such that the surfaces reflect the light and retain it within the windowpane. For example, an end of the windowpane distal to a light source such as the primary light source may be provided with a shape such that light from the light source is reflected back towards the light source through the windowpane. As such, the windowpane may comprise a prism.

It may be that the windowpane system comprises at least one secondary light source, each secondary light source being arranged so that light from the secondary light source passes into the windowpane through a second surface of the windowpane, the light then travelling within the windowpane until it has undergone total internal reflection from one or more surfaces of the windowpane a plurality of times, wherein at least some of the light from the secondary light source is absorbed by the windowpane as the light from the secondary light source passes through the windowpane. With multiple light sources at different locations and different surfaces of the windowpane, the windowpane can be more evenly heated.

It may be that the windowpane system comprises tertiary and further light sources, each tertiary or further light source being arranged so that light from the tertiary or further light source passes into the windowpane through a third or further surface of the windowpane, the light then undergoing total internal reflection from one or more surfaces of the windowpane a plurality of times.

Typically, the majority of photons produced by at least one light source undergo total internal reflection a plurality of times. It may be that 95%, 99%, or substantially all of the photons produced by a light source undergo total internal reflection a plurality of times.

Typically the majority of the photons produced by at least one light source have a frequency which is not visible to the human eye. It may be that the majority of the photons produced by at least one light source have a frequency which is lower than the range of frequencies visible to the human eye. It may be that the majority of the photons produced by at least one light source have a frequency in the infrared spectrum. Since infrared radiation is not visible to the human eye, the light will not then obscure the view through the windowpane. It may be that the majority of the photons produced by at least one light source have a frequency between 300 and 1200 nanometres. It may be that the majority of the photons produced by at least one light source have a wavelength of 300, 800 or 1200 nanometres. It may be that the majority of the photons produced by at least one light source have a wavelength which lies in the range 800 to 1200 nanometres. It may be that the majority of the photons produced by at least one light source have a frequency which is higher than the range of frequencies visible to the human eye. It may be that the majority of the photons produced by at least one light source have a frequency in the microwave spectrum. It may be that at least one light source has a power level between 1.2 and 1.6 watts. It may be that at least one light source has a power level of 1.2 or 1.6 watts.

It may be that the light source produces light in a beam. The beam may be directed into the windowpane as a beam. Also, the light from the light source may be passed through optical equipment such as a prism or lens in order to shape, focus or spread the light before it enters the windowpane.

It may be that the light source produces photons of variable frequency. It may be that the light source produces light of variable intensity.

Typically, at least one light source is a laser. It may be that the at least one light source is a scanning light source such as a scanning laser. It may be that at least one light source is a fluorescent lamp. It may be that at least one light source is a cold cathode fluorescent lamp, such as a focussed cold cathode fluorescent lamp. It may be that at least one light source is an LED or any other suitable light source.

Typically, the windowpane comprises two members, a first member comprising said first surface, and a second member. The second member is arranged adjacent to a surface of the first member such that the light from the primary light source undergoes total internal reflection from the boundary between the first member and the second member.

The windowpane may comprise a plurality of second members, each arranged adjacent to one or more surfaces of the first member. The second members may be adhered to the first member.

It may be that the windowpane system comprises at least a first sensor suitable for detecting radiation from the primary or secondary light source.

In accordance with a second aspect of the present invention there is provided a method for heating a windowpane, the method comprising:
providing a windowpane system comprising a windowpane and at least one primary light source; and
passing light from the primary light source into the windowpane through a first surface of the windowpane, such that the light then travels within the windowpane until it has undergone total internal reflection from one or more surfaces of the windowpane a plurality of times,
wherein at least some of the light from the primary light source is absorbed by the windowpane as the light from the primary light source passes through the windowpane.

The windowpane system use in the second aspect of the invention may be any windowpane system described with reference to the first aspect of the invention above.

Typically, the windowpane system according to the second aspect comprises at least one secondary light source, the method further comprising:
passing light from the secondary light source into the windowpane through a second surface of the windowpane, such that the light then travels within the windowpane until it has undergone total internal reflection from one or more surfaces of the windowpane a plurality of times,
wherein at least some of the light from the secondary light source is absorbed by the windowpane as the light from the secondary light source passes through the windowpane.

In accordance with a third aspect of the present invention there is provided a method for determining the condition of a windowpane, the method comprising:
providing a windowpane system comprising a windowpane, at least one primary light source and at least a first sensor suitable for detecting radiation from the primary light source;
passing light from the primary light source into the windowpane through a first surface of the windowpane, such that the light then travels within the windowpane until it has undergone total internal reflection from one or more surfaces of the windowpane a plurality of times;
detecting light from the primary source with a sensor; and
determining the condition of the windowpane by comparing the sensed light level with a first expected sensed light level.

Chips, cracks and other flaws in the windowpane may alter the transmission of the through the windowpane. Similarly, water, dust, dirt or any other accretion on the windowpane may also alter the transmission through the windowpane. Therefore both may be detected by comparing the sensed light level with an expected sensed light level. The first expected sensed light level may comprise an expected sensed light level for an intact and clean windowpane. The invention may further comprise comparing the sensed light level with a second expected sensed light level. The second expected sensed light level may comprise an expected sensed light level for a windowpane which has been damaged, covered in dirt, covered in dust, rained on, or otherwise altered.

The method may further comprise providing a windowpane cleaning device and activating the windowpane cleaning device if the sensed light level is not the first expected sensed light level. The windowpane cleaning device may comprise a windscreen wiper, a water jet or any other suitable device. The method may further comprise providing a windowpane cleaning device and activating the windowpane cleaning device if the sensed light level is a second expected sensed light level.

The method may comprise detecting light from the primary light source with a sensor a plurality of times and comparing the plurality of detected light levels with an expected pattern of sensed light levels.

In accordance with a fourth aspect of the present invention there is provided a method for detecting a flaw in a windowpane, the method comprising:
providing a windowpane system comprising a windowpane, at least one primary light source and at least a first sensor suitable for detecting radiation from the primary light source;
passing light from the primary light source into the windowpane through a first surface of the windowpane, such that the light then travels within the windowpane until it has undergone total internal reflection from one or more surfaces of the windowpane a plurality of times;
detecting light from the primary or secondary light source with the first sensor;
comparing the sensed light level with an expected sensed light level; and
creating a record of a fault if the sensed light level is not the expected sensed light level.

The windowpane system use in the third or fourth aspect of the invention may be any windowpane system described with reference to the first aspect of the invention above, provided that it has a suitable sensor or sensors.

Typically, the windowpane system according to the third or fourth aspect comprises at least one secondary light source, the method further comprising:
passing light from the secondary light source into the windowpane through a second surface of the windowpane, such that the light then travels within the windowpane until it has undergone total internal reflection from one or more surfaces of the windowpane a plurality of times,
detecting light from the secondary source with a sensor;
comparing the sensed light level with an expected sensed light level; and
creating a record of a fault if the sensed light level is not the expected sensed light level.

It may be that the method for detecting a flaw in a windowpane further comprises altering the behaviour of the primary or secondary light source if the sensed light level is not the expected sensed light level. Typically, altering the behaviour of the primary or secondary light source comprises disabling the first or second light source. Alternatively, altering the behaviour of the primary or secondary light source may comprise reducing the function of the light source. For example, in the case of a scanning light source which can emit light in more than one direction, altering the behaviour of the light source may comprise preventing the light source from emitting light in a particular direction or set of directions.

Typically, a windowpane comprises multiple layers, for example two layers of glass surrounding a layer of polyvinyl butyral (PVB). It may be that light from the primary or secondary light source is restricted to a single layer of the windowpane. For example, it may be that the light from the primary or secondary light source is arranged to pass through a layer of the windowpane in order to heat that layer up most effectively, and so help to prevent fogging on the outer surface of that layer, for example. It may be that light from the primary or secondary light source passes through multiple layers of the windscreen.

Alternatively, it may be that the light from the primary or secondary light source is arranged to pass through a plastic layer of the windowpane, such as a PVB layer. It may be that the plastic material used for the windowpane is chosen at least in part for its optical properties, such as the ability to transmit the light from the primary or secondary light source. This can be advantageous since it is often simpler to vary the optical properties of a plastic than to vary the optical properties of glass. As such, the PVB layer or another plastic layer can be “tuned” to provide the best results. It may be that the optical properties of the plastic layer vary, for example by doping the plastic with other materials in some areas. This can be used to ensure better absorption or transmission of light from the primary or secondary light sources in certain areas. For example, the PVB layer may be arranged to absorb more light from the primary and secondary light sources on its outer surfaces, such that heat is provided more efficiently to the outside of the windowpane, where it will best melt ice and clear fogging. Similarly, the thickness of surrounding layers may be varied to provide the best results. For example, in a windowpane comprising an inner glass layer, a PVB layer and an outer glass layer, the outer glass layer over a plastic layer could be thin in order that ice will melt quickly when the PVB layer is heated by a primary or secondary light source. The inner glass layer could then be thicker to provide structural support to the windowpane.

It may be that the absorption coefficient of a layer of the windowpane has a gradient.

Altering the behaviour of the primary or secondary light source may comprise preventing the light source from emitting light in a particular layer of the windowpane. It may be that altering the behaviour of the primary or secondary light source comprises preventing the light source from emitting light in a particular direction or set or directions in a particular layer. For example, if a first glass layer of a windowpane has been damaged, light from the primary or secondary light source may be contained within a PVB layer, a second glass layer, or both, in order to avoid the light being scattered by the damage in the first layer.

Where a light source in an embodiment produces a beam, it may be that altering the behaviour of the primary or secondary light source comprises changing the beam shape or beam width.

It may be that the method for detecting a flaw in a windowpane comprises:
providing a windowpane system comprising a plurality of sensors suitable for detecting radiation from the primary or secondary light source;
causing at least one primary or secondary light source to emit light;
detecting light from the primary or secondary light source with a sensor;
comparing the sensed light level at the sensor with an expected sensed light level; and
creating a record of a fault if the sensed light level for a sensor is not the expected sensed light level,
wherein the record of the fault is associated with a region of the windowpane, the region depending upon which sensor senses a light level which is not the expected sensed light level.

It may be that a primary or secondary light source comprises a scanning light source, wherein the scanning light source can emit light in more than one direction, and the method for detecting a flaw in a windowpane comprises:
detecting light from the first scanning light source with a sensor while the first scanning light source is emitting light in a first direction;
comparing the sensed light level at the sensor with an expected sensed light level; and
creating a record of a fault if the sensed light level is not the expected sensed light level,
wherein the record of the fault is associated with a region of the windowpane, the region depending upon the first direction.

Where the light source produces photons of variable frequency, it may be that a method according to second, third or fourth aspect of the invention comprises:
detecting the temperature of the windowpane; and
varying the frequency of the photons according to the temperature of the windowpane.

Where the light source produces light of variable intensity, it may be that a method according to second, third or fourth aspect of the invention comprises:
detecting the temperature of the windowpane; and
varying the intensity of the light according to the temperature of the windowpane.

It may be that the windowpane system comprises a plurality of scanning light sources. Where this is the case, the method may further comprise triangulating a location from the directions associated with the record of a fault detected by more than one scanning light source.

It may be that in a windowpane system, method or vehicle as described above the angle of incidence for light from at least one primary light source at the first surface of the windowpane is substantially zero. It may be that the angle of incidence for light from at least one secondary light source at the second surface of the windowpane is substantially zero. Tertiary or further light sources may be similarly arranged. This is possible, while still achieving total internal reflection, since windowpanes are often curved, such that a straight beam of light within the windowpane eventually reaches an outer surface of the pane regardless of its angle of entry.

In accordance with a further aspect of the present invention there is provided a vehicle which comprises a windowpane system as described above. It may be that the vehicle further comprises a control unit configured to carry out any of the methods described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. For example, features described in connection with one aspect or embodiment are applicable to all aspects or embodiments, except where such features are incompatible.

### BRIEF DESCRIPTION OF THE DRAWINGS

Embodiments of the invention will now be described, by way of example only, with reference to the accompanying drawings, in which:

FIG. 1 is a cross section of a windowpane system according to an embodiment of the invention;

FIG. 2 shows a perspective view of a second windowpane system;

FIG. 3 shows a plan view of a third windowpane system;

FIG. 4 shows a plan view of a fourth windowpane system;

FIG. 5 shows a plan view of a fifth windowpane system;

FIG. 6 shows a plan view of a sixth windowpane system;

FIG. 7 shows a plan view of a seventh windowpane system; and

FIG. 8 shows a cross section of an eighth windowpane system.

### DETAILED DESCRIPTION

FIG. 1 shows a cross section of a first windowpane system 101. The first windowpane system 101 is a windshield of a vehicle, and comprises a first glass sheet 102 which is provided with a first layer of cladding 103 and second layer of cladding 104. The cladding 103, 104 helps to protect the first glass sheet 102 from damage such as chipping, and can also provide advantageous optical effects such as reducing glare due to sunlight reflecting from objects in front of the vehicle.

The first windowpane system 101 further comprises a first infrared laser 105. The first infrared laser 105 is positioned so that, when activated, it will direct a first beam of light 106 into the first glass sheet 102. The first beam of light 106 is refracted as it enters the first glass sheet 102, and directed towards the first layer of cladding 103. The first layer of cladding 103 is made from a substance chosen to have a lower refractive index than the first glass sheet 102, and the first infrared laser 105 is positioned such that the first beam of light 106 hits the boundary between the first glass sheet 102 and the first layer of cladding 103 at an angle α, where α is greater than the critical angle of the medium boundary.

Therefore the first beam of light 106 undergoes total internal reflection, and is reflected towards the second layer of cladding 104. The first beam of light 106 also reflects from the boundary between the first glass sheet 102 and the second layer of cladding 104, and proceeds to bounce back and forth between the boundaries down the first glass sheet 102 as illustrated in FIG. 1.

As the beam travels through the first glass sheet, photons in the first beam of light 106 are absorbed by the glass, and so energy is absorbed from the beam by the glass. Therefore the energy of the first glass sheet 102 increases, raising the temperature of the glass. Therefore the first beam of light 106 can heat up the first glass sheet 102. When the temperature is raised enough, any ice on the outside of the first windowpane system 101 will melt, and any water droplets will tend to evaporate, clearing both ice and fog from the first windowpane system 101.

Since the laser is an infrared laser, the first beam of light 106 is not visible to the driver of the vehicle. Due to the absorption of the photons, the beam of light 106 attenuates as it passes through the first glass sheet 102. The rate of attenuation depends upon the optical properties of the materials which comprise the first glass sheet 102, as well as the frequency of the first beam of light 106. The first glass sheet 102 can be doped with various impurities to adjust the absorption rate of the beam of light 106 without adversely affecting visibility for the driver. The first glass sheet 102 and the frequency of the first beam of light 106 is chosen so that the intensity of the first beam of light 106 approaches nothing as the first beam of light 106 approaches the distal end of the first glass sheet 107. In this way, the amount of energy lost in photons escaping through the distal end of the first glass sheet 107 is minimised.

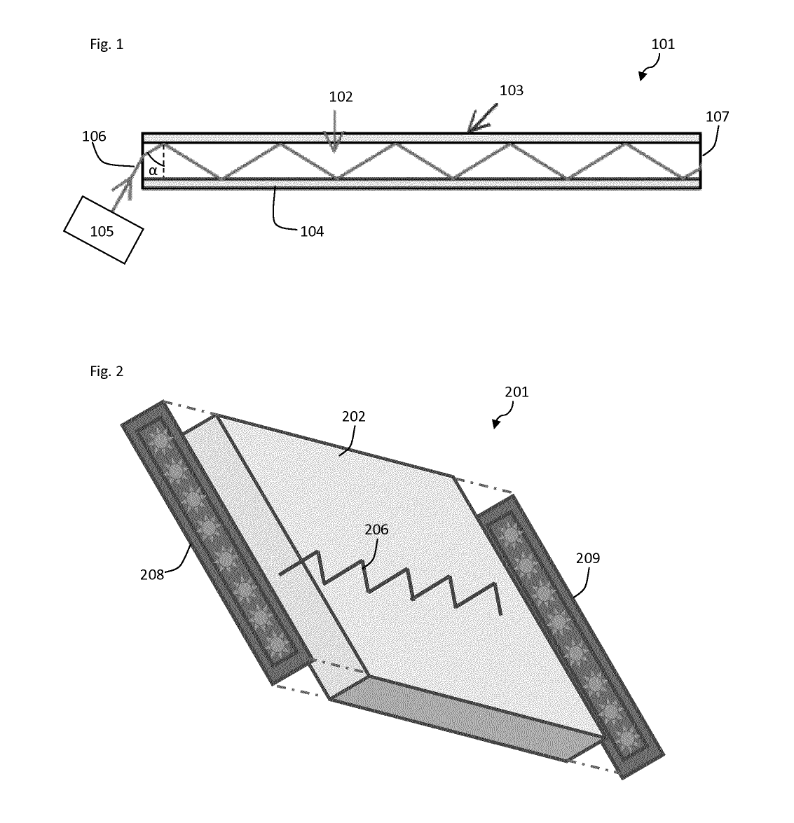

FIG. 2 shows a second windowpane system 201. The second windowpane system 201 comprises a second glass sheet 202 and a plurality of infrared lasers arranged in a first array 208. The first array 208 produces multiple beams of light which bounce light through the second glass sheet 202, and cause heating as explained above. One beam of light, the second beam 206, is illustrated in FIG. 2, but in use there would be at least one beam per infrared laser. The second windowpane system 201 does not comprise cladding, but since the refractive index of air is lower than the refractive index of the second glass sheet 202, the second beam of light 206 still undergoes total internal reflection and remains within the second glass sheet 202.

The second windowpane system 201 further comprises a second array of lasers 209, which also transmit beams of light through the glass and help to heat the second glass sheet 202. In the embodiment shown in FIG. 2, the first and second array of lasers 208, 209 are tuned so that the light from each propagates across substantially all of the second glass sheet 202, so that the beams pass each other. Alternatively, the lasers and the material used in the second glass sheet 202 can be tuned so that each array of lasers 208, 209 propagates light across only half the length of the second glass sheet 202, so that each beam starts at an array but only travels half way to the other array before it is absorbed completely, or substantially completely. In this embodiment, each array heats half the glass sheet 202.

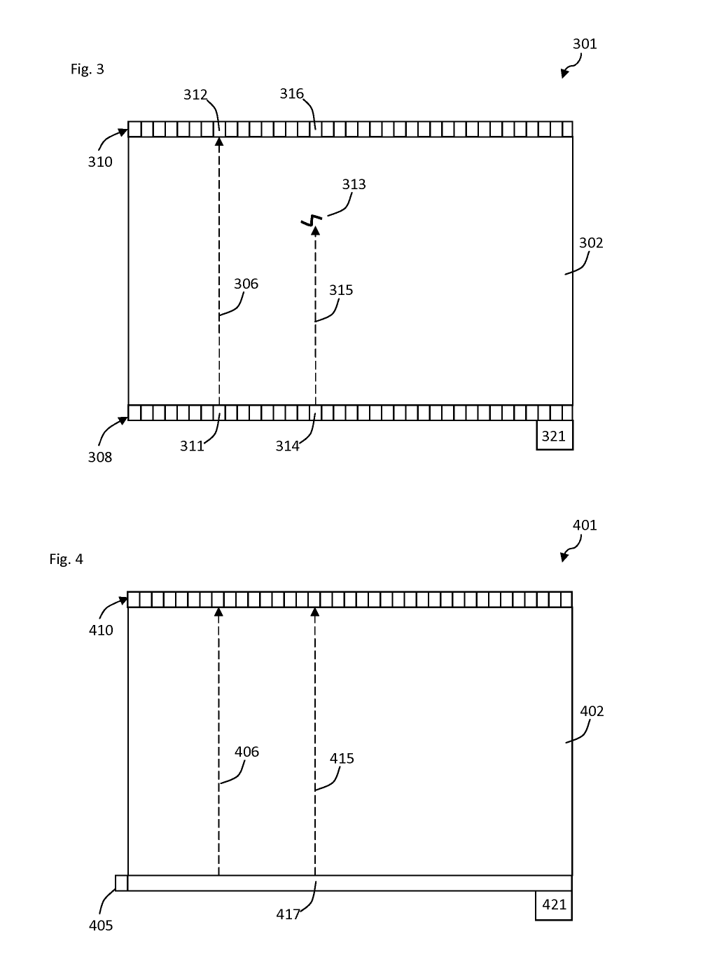

FIG. 3 shows a third windowpane system 301, which is also suitable for use in a vehicle. The third windowpane system 301 comprises a third glass sheet 302 and a plurality of infrared lasers arranged in a third array 308. Each of the infrared lasers 105 in the third array 308 produces a beam of light which bounces across the third glass sheet 302 as illustrated, for example, by the third beam 306.

The third windowpane system 301 further comprises a fourth array 310. However the fourth array 310 does not comprise lasers. Rather, the fourth array comprises a plurality of light sensors, each of which is suitable for detecting light of the frequency produced by an infrared laser.

The third windowpane system 301 also comprises a first control unit 321 which controls the activation of the lasers in the third array 308 and receives signals from the sensors in the fourth array 310. Each sensor in the fourth array 310 is arranged to provide a signal to the first control unit 321 when a beam of the frequency produced by the infrared laser is detected by the sensor.

In use, a second infrared laser 311 in the third array 308 produces the third beam 306. The third beam 306 crosses the third glass sheet 302 to a first sensor 312, the third beam 306 heating the third glass sheet 302 as it passes through it. In contrast to the first beam of light 106 described in reference to FIG. 1 above, the frequency of the third beam of light 306 is chosen so that the intensity of the third beam of light 306 is greater than zero as the third beam of light 306 approaches the first sensor 312. The first sensor 312 can therefore detect the third beam of light 306.

In the event that the third glass sheet 302 develops a flaw, such as the first crack 313 illustrated in FIG. 3, this may impede the transmission of a beam of light. In the third windowpane system 301, a third infrared laser 314 in the third array 308 produces a fourth beam 315, which is transmitted through the third glass sheet 302 towards a second sensor 316. However, the beam is disrupted by the first crack 313, and does not reach the second sensor 316. Therefore the second sensor 316 does not provide a signal to the control unit.

Therefore the first control unit 321, having instructed the third infrared laser 314 to produce a beam of light, can diagnose that a problem has occurred. Two possible explanations for the problem are: (i) that a fault has occurred which prevents the operation of the laser, the sensor or both; or (ii) that a crack or other flaw has developed in the third glass sheet 302 and is preventing the transmission of the beam.

The first control unit 321 then records a fault and disables the third infrared laser 314. Disabling the third infrared laser 314 helps to prevent wasting power, and also prevents the fourth beam 315 from heating the first crack 313, which might further weaken the third glass sheet 302.

Since the fault is associated with a particular sensor, or a set of sensors in the event that a crack disrupts more than one beam's transmission, the fault is therefore also associated with a region of the third glass sheet. In the case of the first crack 313, this region is the volume through which the fourth beam 315 would normally propagate. Therefore, when the vehicle is serviced, the engineer performing the service can access the record of the fault and determine that they should inspect the third infrared laser 314, the second sensor 316 and the region of the third glass sheet 302 through which the fourth beam 315 would normally propagate. Detecting a flaw early may allow it to be repaired more easily than would be the case if the flaw was only detected once it became more obvious.

The first control unit 321 can also be configured to provide information to the driver of the car, so that the driver knows that they should have their windowpane checked in the event of a fault. This could be of use to the driver since flaws in a windowpane may not be obvious to the naked eye, but any flaws may still contribute to a weakening of the glass sheet.

A crack in the third glass sheet 302 may also divert and split a beam of light so that it arrives at more than one sensor. As such, a first flaw in the third glass sheet 302 may mask other flaws by causing sensors to provide false positive readings. To prevent this, the first control unit 321 is arranged to periodically operate in a test pattern.

In the test pattern, the first control unit 321 causes each infrared laser in the third array 308 to transmit a beam in turn, and monitors the signals from the sensors in the fourth array 310. Since each infrared laser 308 is operated by itself, false positive results become obvious and can be recorded as faults, and false positives cannot mask missing signals.

In an embodiment of the third windowpane system 301, the first control unit 321 is arranged to only operate the sensors in the fourth array 310 when it is in a test pattern. The rest of the time the sensors are deactivated to save power. The first control unit 321 may be arranged to enter a test pattern when the vehicle is turned on or off, or when the window heating is activated or deactivated. Alternatively, the first control unit 321 may be arranged to operate the sensors in the fourth array 310 whenever the infrared lasers are active.

As the third beam of light 306 propagates through the third glass sheet 302, the reflection of the beam from the edges of the third glass sheet 302 is dependent upon the refractive indices at the borders of the third glass sheet 302. If the third glass sheet 302 is covered in dirt or water, for example due to rain, then, since the refractive index of the dirt or water will be different to air, this can change the behaviour of the third beam of light 306. In particular, the third beam of light may not be properly reflected, and a portion of the light may pass through or be absorbed by the dirt or water.

This leads to a characteristic reduction in the light detected by the first sensor 312. The first control unit 321 compares the reduced light levels to expected light levels for (i) a clean glass sheet, (ii) a wet glass sheet and (iii) a dirt covered glass sheet and diagnoses whether the window is clean, wet or dirty. If the glass sheet 302 is wet, the first control unit 321 activates a windscreen wiper (not shown) to clear water. If the glass sheet 302 is dirty, the first control unit 321 activates a spray of water directed at the glass sheet 302 as well as the windscreen wiper in order to clean the glass sheet 302.

If it is raining, the rain drops landing on the windscreen cause periodic fluctuations in the light levels detected by the first sensor 312. The control unit 321 therefore records a plurality of measurements taken by the first sensor 312 and checks for periodic changes. If they are present, then the control unit 321 again activates a windscreen wiper to clear the window.

In an alternate arrangement, sensors and lasers can be arranged in an alternating arrangement on each side of the third glass sheet 302, so that each laser is place between two sensors, but still emits light towards a sensor on the far side of the glass sheet.

The sensors and lasers shown in FIG. 3 can be arranged along any edge of a windowpane, so that the arrays are horizontal, vertical, or at any desired angle.

FIG. 4 shows a fourth windowpane system 401. The fourth windowpane system comprises a fourth sheet of glass 402 and an array of sensors 410 similar to those found in the third windowpane system 301. The fourth windowpane system 401 also comprises a second control unit 421. However, in place of the third array 308, the fourth windowpane system comprises a single infrared laser 405 and a prism 417. The prism 417 causes the fifth beam 406, which is produced by the infrared laser 405, to split up and propagate on multiple different axes across the glass sheet of the fourth windowpane system 401.

Errors can still be detected and connected to a specific region in the fourth windowpane system 401 using the array of sensors 410, as described above.

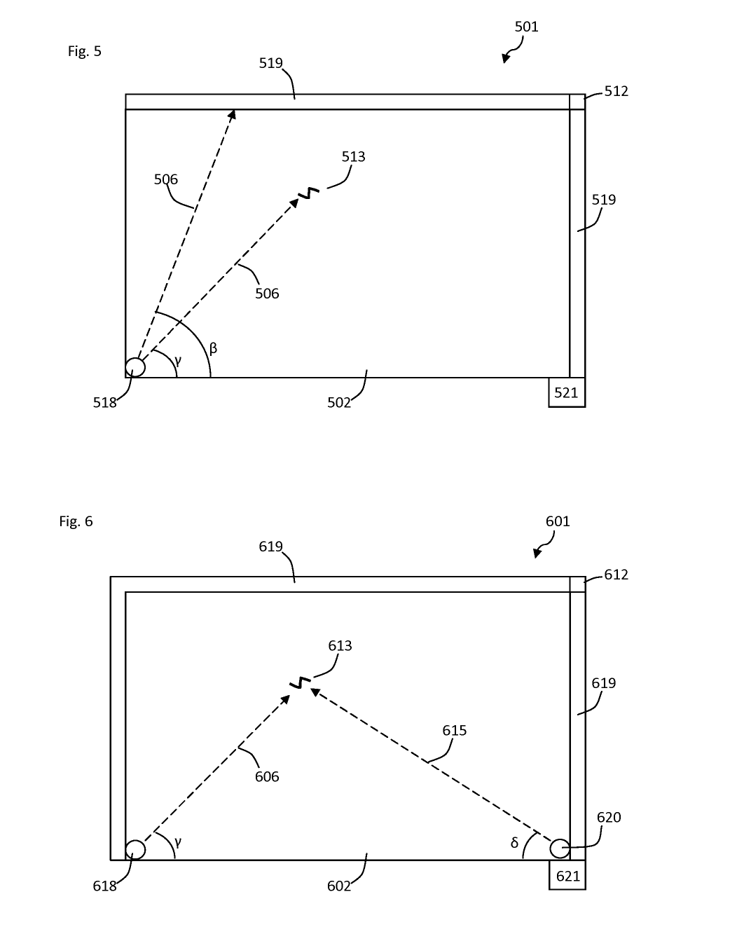

FIG. 5 shows a fifth windowpane system 501. The fifth windowpane system comprises a fifth glass sheet 502 and a third control unit 521. The fifth windowpane system also comprises a first scanning infrared laser 518. The first scanning infrared laser 518 can transmit a sixth beam 506 through the fifth glass sheet 502 at a range of angles. As such, the first scanning infrared laser can heat any region of the glass sheet 502 by reorienting the sixth beam 506.

In normal operation, the third control unit 521 causes the first scanning infrared laser 518 to sweep the sixth beam 506 back and forth across the fifth glass sheet 502, in order to ensure even heating. Therefore, at time t₁, the sixth beam 506 may be directed at an angle β across the fifth glass sheet 502. Then, subsequently at time t₂, the sixth beam 506 would be directed at an angle γ across the glass sheet 502. The first scanning infrared laser 518 can vary the intensity of the sixth beam 506 can vary depending upon scan position to ensure even heating.

The fifth windowpane system 501 further comprises prisms 519. The prisms are shaped and arranged to direct the beam towards a third sensor 512, which provides a signal to the third control unit 521, in a similar manner to that described above with reference to FIGS. 3 and 4.

If the sixth beam 506 is disrupted by a flaw such as the second crack 513, then the signal from the third sensor 512 is also disrupted, and this will be detected by the third control unit 521. As such, the third control unit 521 can record that a flaw was detected when the sixth beam was directed at an angle γ across the fifth glass sheet 502. The fault is therefore associated with a region of the fifth glass sheet 502, the region being the volume through which the sixth beam 506 would normally propagate when projected at an angle γ. As above, when the vehicle is serviced, the engineer will then know which part of the windowpane to inspect.

Once a flaw is detected at angle γ, the third control unit 521 may be configured to automatically prevent the first scanning infrared laser 518 from transmitting a beam at an angle γ.

FIG. 6 shows a sixth windowpane system 601. The sixth windowpane system 601 is similar to the fifth windowpane system 501 in that the sixth windowpane system comprises a sixth glass sheet 602, prisms 619, a fourth sensor 612, a fourth control unit 621 and a second scanning infrared laser 618, all of which function in a similar way to the corresponding components described above with reference to FIG. 5. However the sixth windowpane system 601 also comprises a third scanning infrared laser 620.

The second scanning infrared laser 618 transmits a seventh beam 606 through the sixth glass sheet 602 to the prism 619, so that it is detected by the fourth sensor 612. The third scanning infrared laser 618 transmits an eighth beam 615, also through the sixth glass sheet 602 to the prism 619, so that it is detected by the fourth sensor 612. Both lasers cause their beams to sweep back and forth across the sixth glass sheet 602 in order to ensure even heating.

If either beam hits a flaw in the sixth glass sheet 602, such as third crack 613, then it is disrupted, and this causes a change in the intensity of the light received by the fourth sensor 612. The fourth sensor 612 then transmits a signal indicating this change in intensity to the fourth control unit 621, and the fourth control unit 621 enters a test mode.

In the test mode, the fourth control unit 621 deactivates the third scanning infrared laser 620 and causes the second scanning infrared laser 618 to sweep the sixth glass sheet 602 with the seventh beam 606 while monitoring the intensity of the light detected by the fourth sensor 612. In this way the fourth control unit 621 can determine that the third crack 613 lies on the line of the seventh beam 606 when the beam is transmitted at an angle γ.

Next, the fourth control unit 621 deactivates the second scanning infrared laser 618 and causes the third scanning infrared laser 620 to sweep the sixth glass sheet 602 with the eighth beam 615 while monitoring the intensity of the light detected by the fourth sensor 612. In this way the fourth control unit 621 can determine that the third crack 613 lies on the line of the eighth beam 615 when the beam is transmitted at an angle δ.

The fourth control unit 621 can then record that a flaw was detected, and the angle data associated with the flaw. Using the angle data, it is possible to triangulate the location of the flaw, providing guidance to an engineer who inspects the sixth glass sheet during a service.

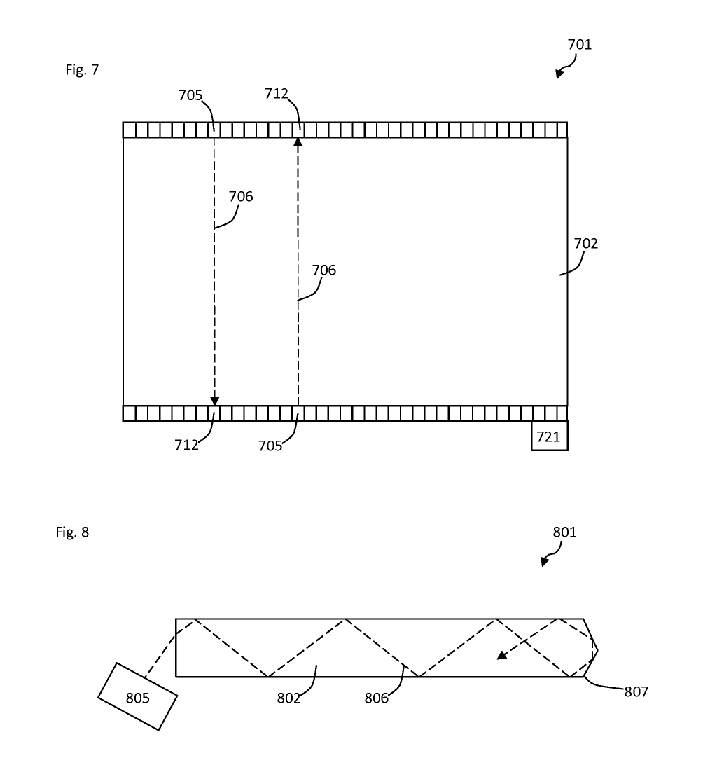

FIG. 7 shows a seventh windowpane system 701. The seventh windowpane system 701 is similar to the second windowpane system 201 in that there are infrared lasers 705 arranged on both sides of the seventh glass sheet 702. There is also a control unit 721. The seventh windowpane system 701 comprises two arrays of alternating lasers 705 and sensors 712, arranged on each side of the seventh glass sheet 702 such that each laser faces a sensor. The beams 706 propagate across the glass sheet, causing heating and helping to detect flaws as described above in relation to FIG. 3. As the intensity of laser light decreases as the laser is absorbed, each laser 705 tends to heat those sections of the glass which are closer to the laser more than those sections of the glass which are further away. Therefore providing lasers on both sides of the glass sheet 702 tends to provide more even heating across the sheet.

FIG. 8 shows a cross section of an eighth windowpane system 801. The eighth windowpane system 801 is similar to the first windowpane system 101 in that an infrared laser 805 is arranged to provide an eighth beam of light 806 which propagates through an eighth glass sheet 802 while undergoing total internal reflection when it reaches the boundaries of the sheet. The distal end 807 of the glass sheet is provided with a trapezoidal cut such that the eighth beam of light 806 is reflected back into the glass sheet from the distal end, as illustrated.

As such the eighth beam of light is reflected such that it remains within the eighth glass sheet 802 such that the photons can continue to be absorbed by the glass.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Further aspects of the present invention are outlined in the following series of numbered paragraphs:

1. A windowpane system comprising:
a windowpane; and
at least one primary light source;
the or each primary light source being arranged so that light therefrom passes into the windowpane through a first surface of the windowpane, the light then travelling within the windowpane until it has undergone total internal reflection from one or more surfaces of the windowpane a plurality of times,
wherein at least some of the light from the or each primary light source is absorbed by the windowpane.
   2. A windowpane system according to numbered paragraph 1, wherein the windowpane is heated by absorption of photons by the windowpane.
   3. A windowpane system according to numbered paragraph 1 or numbered paragraph 2, wherein the material of the windowpane is chosen to provide a predefined absorption rate for photons of a frequency produced by the or each primary light source.
   4. A windowpane system according to numbered paragraph 1, numbered paragraph 2 or numbered paragraph 3, the windowpane comprising at least one secondary light source, the or each secondary light source being arranged so that light therefrom passes into the windowpane through a second surface of the windowpane, the light then travelling within the windowpane until it has undergone total internal reflection from one or more surfaces of the windowpane a plurality of times,
wherein at least some of the light from the or each secondary light source is absorbed by the windowpane.
   5. A windowpane system according to any preceding numbered paragraph, wherein the majority of the photons produced by at least one light source have a frequency in the infrared spectrum.
   6. A windowpane system according to any preceding numbered paragraph, wherein at least one light source is a laser.
   7. A windowpane system according to any preceding numbered paragraph, wherein at least one light source is a scanning light source.
   8. A windowpane system according to any preceding numbered paragraph, wherein the windowpane comprises:
a first member comprising said first surface; and
a second member, the second member being arranged adjacent to a surface of the first member such that the light from the primary light source undergoes total internal reflection from the boundary between the first member and the second member.
   9. A windowpane system according to any preceding numbered paragraph, the windowpane comprising at least a first sensor suitable for detecting radiation from the primary or secondary light source.
   10. A method of heating a windowpane, the method comprising:
providing a windowpane system comprising a windowpane and at least one primary light source; and
passing light from the primary light source into the windowpane through a first surface of the windowpane, such that the light then travels within the windowpane until it has undergone total internal reflection from one or more surfaces of the windowpane a plurality of times,
wherein at least some of the light from the primary light source is absorbed by the windowpane as the light from the primary light source passes through the windowpane.
   11. A method according to numbered paragraph 10, wherein the windowpane system comprises at least one secondary light source, the method further comprising:
passing light from the secondary light source into the windowpane through a second surface of the windowpane, such that the light then travels within the windowpane until it has undergone total internal reflection from one or more surfaces of the windowpane a plurality of times,
wherein at least some of the light from the secondary light source is absorbed by the windowpane as the light from the secondary light source passes through the windowpane.
   12. A method for determining the condition of a windowpane, the method comprising:
providing a windowpane system comprising a windowpane, at least one primary light source and at least a first sensor suitable for detecting radiation from the primary light source;
passing light from the primary light source into the windowpane through a first surface of the windowpane, such that the light then travels within the windowpane until it has undergone total internal reflection from one or more surfaces of the windowpane a plurality of times;
detecting light from the primary source with a sensor;
determining the condition of the windowpane by comparing the sensed light level with a first expected sensed light level.
   13. A method according to numbered paragraph 12, the method further comprising providing a windowpane cleaning device and activating the windowpane cleaning device if the sensed light level is not the first expected sensed light level.
   14. A method for detecting a flaw in a windowpane, the method comprising:
providing a windowpane system comprising a windowpane, at least one primary light source and at least a first sensor suitable for detecting radiation from the primary light source;
passing light from the primary light source into the windowpane through a first surface of the windowpane, such that the light then travels within the windowpane until it has undergone total internal reflection from one or more surfaces of the windowpane a plurality of times;
detecting light from the primary source with a sensor;
comparing the sensed light level with an expected sensed light level; and
creating a record of a fault if the sensed light level is not the expected sensed light level.
   15. A method according to numbered paragraph 14, wherein the windowpane system comprises at least one secondary light source, the method further comprising:
passing light from the secondary light source into the windowpane through a second surface of the windowpane, such that the light then travels within the windowpane until it has undergone total internal reflection from one or more surfaces of the windowpane a plurality of times,
detecting light from the secondary source with a sensor;
comparing the sensed light level with an expected sensed light level; and
creating a record of a fault if the sensed light level is not the expected sensed light level.
   16. A method according to numbered paragraph 14 or numbered paragraph 15, the method further comprising:
altering the behaviour of the primary or secondary light source if the sensed light level is not the expected sensed light level.
   17. A method according to numbered paragraph 16, wherein altering the behaviour of the primary or secondary light source comprises disabling the primary or secondary light source.
   18. A method according to any of numbered paragraphs 14 to 17, the method comprising:
providing a windowpane system comprising a plurality of sensors suitable for detecting radiation from the primary or secondary light source;
causing at least one primary or secondary light source to emit light;
detecting light from the primary or secondary light source with a sensor;
comparing the sensed light level at the sensor with an expected sensed light level; and
creating a record of a fault if the sensed light level for a sensor is not the expected sensed light level,
wherein the record of the fault is associated with a region of the windowpane, the region depending upon which sensor senses a light level which is not the expected sensed light level.
   19. A method according to any of numbered paragraphs 14 to 18, wherein a primary or secondary light source comprises a scanning light source, wherein the scanning light source can emit light in more than one direction, the method further comprising:
detecting light from the first scanning light source with a sensor while the first scanning light source is emitting light in a first direction;
comparing the sensed light level at the sensor with an expected sensed light level; and
creating a record of a fault if the sensed light level is not the expected sensed light level,
wherein the record of the fault is associated with a region of the windowpane, the region depending upon the first direction.
   20. A vehicle comprising a windowpane according to any of numbered paragraphs 1 to 9.
   21. A vehicle according to numbered paragraph 20, the vehicle further comprising a control unit configured to carry out the method of any of numbered paragraphs 10 to 19.
   22. A windowpane system, method or vehicle according to any preceding numbered paragraph, wherein the angle of incidence for light from at least one primary light source at the first surface of the windowpane is substantially zero
   23. A windowpane, a system, a method or a vehicle constructed and/or arranged substantially as described herein with reference to one or more of the accompanying drawings.

1. A windowpane system, comprising:
a windowpane; and
at least one primary light source;
the at least one primary light source being arranged so that light therefrom passes into the windowpane through a first surface of the windowpane, the light then travelling within the windowpane until it has undergone total internal reflection from one or more surfaces of the windowpane a plurality of times,
wherein at least some of the light from the at least one primary light source is absorbed by the windowpane,
wherein the at least one primary light source comprises a scanning light source.

2. The windowpane system of claim 1, wherein the windowpane is heated by absorption of photons by the windowpane.

3. The windowpane system of claim 1, wherein a material of the windowpane provides a predefined absorption rate for photons of a frequency produced by the at least one primary light source.

4. The windowpane system of claim 1, further the comprising at least one secondary light source, the at least one secondary light source being arranged so that light therefrom passes into the windowpane through a second surface of the windowpane and travels, within the windowpane until it has undergone total internal reflection from one or more surfaces of the windowpane a plurality of times,
wherein at least some of the light from the at least one secondary light source is absorbed by the windowpane.

5. The windowpane system of claim 1, wherein a majority of photons produced by the at least one primary light source have a frequency in the infrared spectrum.

6. The windowpane system of claim 1, wherein the at least one primary light source comprises is a laser.

7. (canceled)

8. The windowpane system of claim 1, wherein the windowpane comprises:
a first member comprising the first surface; and
a second member adjacent to a surface of the first member such that the light from the at least one primary light source undergoes total internal reflection from a boundary between the first member and the second member.

9. The windowpane system of claim 4, further comprising a first sensor that detects radiation from the at least one primary light source or the at least one secondary light source.

10. A method of heating a windowpane via at least one primary light source, the method comprising:
passing light from the at least one primary light source into the windowpane through a first surface of the windowpane, such that the light then travels within the windowpane until it has undergone total internal reflection from one or more surfaces of the windowpane a plurality of times,
wherein at least some of the light from the at least one primary light source is absorbed by the windowpane as the light from the at least one primary light source passes through the windowpane, and
wherein the at least one primary light source comprises a scanning light source.

11. The method of claim 10, further comprising:
passing light from at least one secondary light source into the windowpane through a second surface of the windowpane, such that the light then travels within the windowpane until it has undergone total internal reflection from one or more surfaces of the windowpane a plurality of times,
wherein at least some of the light from the at least one secondary light source is absorbed by the windowpane as the light from the at least one secondary light source passes through the windowpane.

12-13. (canceled)

14. A method for detecting a flaw in a windowpane, the method comprising:
passing light from at least one primary light source into the windowpane through a first surface of the windowpane, such that the light then travels within the windowpane until it has undergone total internal reflection from one or more surfaces of the windowpane a plurality of times;
detecting light from the at least one primary source with a sensor;
comparing a sensed light level at the sensor with an expected sensed light level; and
creating a record of a fault if the sensed light level is different from the expected sensed light level.

15. The method of claim 14, the method further comprising:
passing light from at least one secondary light source into the windowpane through a second surface of the windowpane, such that the light then travels within the windowpane until it has undergone total internal reflection from one or more surfaces of the windowpane a plurality of times;
detecting light from the at least one secondary light source with a sensor;
comparing a sensed light level at the sensor from the at least one secondary light source with an expected sensed light level from the at least one secondary light source; and
creating a record of a fault if the sensed light level from the at least one secondary light source is different from the expected sensed light level from the at least one secondary light source.

16. The method of claim 15, further comprising:
altering a behavior of the at least one primary light source or the at least one secondary light source if the sensed light level from the at least one primary light source is not the expected sensed light level from the at least one primary light source and/or if the sensed light level from the at least one secondary light source is not the expected sensed light level from the at least one secondary light source.

17. The method according to claim 16, wherein altering the behaviour of the at least one primary light source or the at least one secondary light source comprises disabling the at least one primary light source or the at least one secondary light source.

18. The method of claim 15, the method comprising:
causing the at least one primary light source or the at least one secondary light source to emit light;
detecting light from the at least one primary light source or from the at least one secondary light source with a sensor;
comparing a sensed light level at the sensor with an expected sensed light level; and
creating a record of a fault if the sensed light level is different from the expected sensed light level,
wherein the record of the fault is associated with a region of the windowpane.

19. The method of claim 15, wherein the at least one primary light source or the at least one secondary light source comprises a scanning light source that emits light in more than one direction, the method further comprising:
detecting light from the scanning light source with a sensor while the scanning light source is emitting light in a first direction;
comparing a sensed light level at the sensor with an expected sensed light level; and
creating a record of a fault if the sensed light level is different from net the expected sensed light level,
wherein the record of the fault is associated with a region of the windowpane.

20. A vehicle comprising a windowpane system, the windowpane system comprising:
a windowpane; and
at least one primary light source;
the at least one primary light source being arranged so that light therefrom passes into the windowpane through a first surface of the windowpane and travels within the windowpane until it has undergone total internal reflection from one or more surfaces of the windowpane a plurality of times,
wherein at least some of the light from the at least one primary light source is absorbed by the windowpane, and
wherein the at least one primary light source comprises is a scanning light source.

21. A vehicle comprising a windowpane system, the windowpane system including a windowpane, at least one primary light source, at least one sensor that detects radiation from the at least one primary light source, and a control unit, wherein the control unit is configured to:
pass light from the at least one primary light source into the windowpane through a first surface of the windowpane, such that the light then travels within the windowpane until it has undergone total internal reflection from one or more surfaces of the windowpane a plurality of times,
detect light from the at least one primary source with the at least one sensor;
compare a sensed light level at the at least one sensor with an expected sensed light level; and
create a record of a fault if the sensed light level is different from the expected sensed light level.

22. The windowpane system of claim 1, wherein an angle of incidence for light from the at least one primary light source at the first surface of the windowpane is substantially zero.

23. The a method of claim 10, wherein an angle of incidence for light from the at least one primary light source at the first surface of the windowpane is substantially zero.
